(19) United States
(12) Patent Application Publication
(10) Pub. No.: US 2017/0057289 A1
(43) Pub. Date: Mar. 2, 2017

(54) Wheel

(71) Applicant: Railblaza Limited, Silverdale (NZ)

(72) Inventor: Ross Gregory Pratt, Auckland (NZ)

(73) Assignee: Railblaza Limited

(21) Appl. No.: 15/242,112

(22) Filed: Aug. 19, 2016

(30) Foreign Application Priority Data
Aug. 31, 2015 (NZ) 711637

(51) Int. Cl. B60C 7/14; B60B 9/04

(52) U.S. Cl. CPC B60C 7/143; B60B 9/04

(57) ABSTRACT

A wheel suitable for use on sandy surface that includes an inner rigid support and an outer resilient, airless, tire. The tire has two series of flexible spokes that move when the tire is in use under a load to form a ground engaged section of the tire to assume a substantially flat track portion. The flexible spokes revert to their normal configuration when rotated out of the ground engaged section. Each of the two series of spokes have an arc shape, with the two series of spokes leaning in opposite directions.

### FIELD OF THE INVENTION

A preferred form of the invention relates to a wheel suitable for use on sandy ground.

### BACKGROUND

It is known to use hand-towed wheeled trolleys for transporting kayaks or small watercraft across a sandy beach. However, in soft sand the wheels can dig in, and this can make movement difficult. It is accordingly an object of a preferred form of the invention to go at least some way towards addressing this. However, it should be appreciated that the invention has more general application, and so any objects or advantages applicable to the preferred embodiment should not be seen as a limitation on the scope of the claims. The object of the invention per se is simply to provide the public with a useful choice.

### SUMMARY OF INVENTION

According to one aspect of the invention there is provided a wheel having an inner support and an outer tire, the tire having two series of flexible spokes which are able to move when the tire is in use to cause a ground engaged section of the tire to assume a substantially flat track portion when under load, and to revert to a normal circular tending configuration when turned away from a ground engaging position, wherein the spokes are laid over so that the first series of spokes tend clockwise and the second series of spokes tend counter-clockwise.

Optionally the tire has inner and outer flexible bands and the flexible spokes extend between these.

Optionally the tire is in half portions and the flexible spokes of one half extend in an angular disposition opposite to those of the other half.

Optionally the flexible spokes are each in the shape of an arc.

Optionally the tire is formed such that the flat track portion is able, in normal use, to be as long as at least the diameter of the rest of the wheel.

Optionally the tire is formed such that the flat track portion is able, in normal use, to be as long as half of the diameter of the rest of the wheel.

Optionally the tire is formed such that the flat track portion is able, in normal use, to be as long as quarter of the diameter of the rest of the wheel.

Optionally the tire is formed such that the flat track portion is able, in normal use, to be as long as an eighth of the diameter, or a sixteenth of the diameter of the rest of the wheel.

Optionally the wheel is part of a transporter.

Optionally the wheel is part of a trolley.

Optionally the trolley is suitable for transporting a watercraft.

Optionally the trolley is suitable for transporting a kayak.

Optionally the tire is airless.

### DRAWINGS

Some preferred embodiments of the invention will now be described by way of example and with reference to the accompanying drawings, of which:

FIG. 1 is an isometric view of a wheel for a kayak trolley;

FIG. 2 is an end view of the wheel;

FIG. 3 is a side view of the wheel; and

FIG. 4 illustrates the wheel when in use on loose sand.

### DETAILED DESCRIPTION

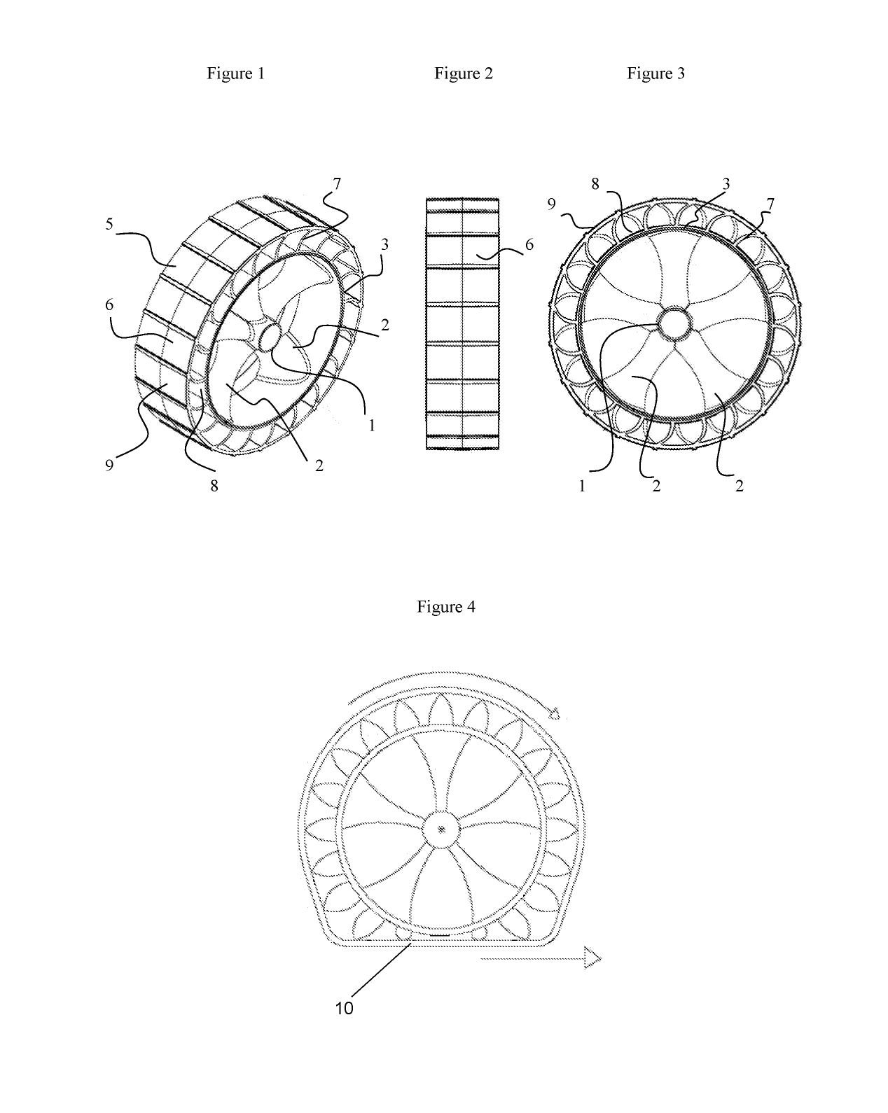

Referring to FIGS. 1, 2 and 3, the wheel has a rigid hub 1 for receiving an axle. A series of rigid spokes 2 extend outwards from the hub to a rigid rim 3. A flexible ground-engaging airless tire 4 is fitted tightly around the rim 3.

As shown in FIGS. 1 and 2, the tire 4 can be conceptually divided into halves 5, 6, one on the left and one on the right. However, they are in reality just different parts of the one piece. Each half 5, 6 has a series of flexible spokes 7 extending between an inner flexible band 8 and an outer flexible band 9. As best shown in FIG. 3, the spokes 7 are not strictly radial; rather they ‘lay over’ in one or other of two directions. More specifically, they are arc like between the inner and outer flexible bands 8, 9. The arcs of one half uniformly lean in one direction, and those of the other half do so in the opposite direction.

When two of the wheels are used as part of a kayak trolley they are each fitted to an axle or axles, which in turn connect to a chassis or upper seat. The kayak is loaded onto the seat and is preferably, although not necessarily, tied or clipped down. A human user then pulls or pushes on the kayak to move it and the trolley from say a car or house to the waterline. This saves the user having to drag the kayak across a sandy or other beach, or having to carrying it on one's shoulders or in one's arms. It makes it easier, for example, for one person to transport the kayak as opposed to having two people do it. In some embodiments the trolley may have a long handle which can be pushed or pulled to move the trolley and kayak.

The weight of some kayaks or watercraft is significant, and so with many known trolleys the wheels readily dig in as they are transported across a soft sandy beach. At times this can make moving the kayak almost as difficult as simply picking it up and carrying it. However, the wheel of the preferred embodiment is specifically designed to address this. Referring to FIG. 4, when a load comes on the wheel in soft sand, its ground-contacting region automatically flattens to become track-like 10. This spreads the load across a larger area of sand and stops, or at least reduces, the tendency of the wheel to ‘dig-in’.

Preferably the wheel is such that it is capable of forming the track-like region 10 to be at least as long as the diameter of the rigid rim 3, or at least half, quarter or an eighth as long as this, in each case while maintaining space between the inner and outer flexible bands 8, 9. Due to the resilience or ‘spring-back’ of the flexible spokes, as the tire turns the part of it that was in contact with the ground ceases to be flat track-like; that is until it comes back around to a ground engaging position.

In one example, the wheel has a diameter of 315 mm. When under load the wheel forms a flat track portion against the ground of approximately 160 mm.

The wheel can be formed on any suitable materials and in any suitable dimensions to match its intended end-use. For example, the tire may be formed of rubber and the rigid inner spokes formed from a hard plastic. Somewhat less flexible materials may be used for the tire in cases where the wheel is intended for use with heavier craft, such as large touring kayaks or dinghies. The same wheel concept may be used for other transporters, for example with wheelbarrows or powered vehicles, etc.

In preferred embodiments of the invention the tire is a permanent part of the wheel, i.e. it cannot be removed without destructive force. However, in other embodiments it may be readily replaceable.

While some preferred embodiments have been described by way of example it should be appreciated that modifications and improvements can be made without departing from the scope of the invention.

1. A wheel having an inner support and an outer tire, the tire having two series of flexible spokes which are able to move when the tire is in use to cause a ground engaged section of the tire to assume a substantially flat track portion when under load, and to revert to a normal circular tending configuration when turned away from a ground engaging position, wherein the spokes are laid over so that the first series of spokes tend clockwise and the second series of spokes tend counter-clockwise.

2. A wheel according to claim 1, wherein the tire has inner and outer flexible bands and the flexible spokes extend between these.

3. A wheel according to claim 1, wherein the tire is in half portions and the flexible spokes of one half extend in an angular disposition opposite to those of the other half.

4. A wheel according to claim 1, wherein the flexible spokes are each in the shape of an arc.

5. A wheel according to claim 1, wherein the tire is formed such that the flat track portion is able, in normal use, to be as long as at least the diameter of the rest of the wheel.

6. A wheel according to claim 1, wherein the tire is formed such that the flat track portion is able, in normal use, to be as long as at least half of the diameter of the rest of the wheel.

7. A wheel according to claim 1, wherein the tire is formed such that the flat track portion is able, in normal use, to be as long as at least a quarter of the diameter of the rest of the wheel.

8. A wheel according to claim 1, wherein the tire is formed such that the flat track portion is able, in normal use, to be as long as at least an eighth of the diameter of the rest of the wheel.

9. A wheel according to claim 1, wherein the tire is airless.

10. A wheel according to claim 1, forming part of a transporter.

11. A wheel according to claim 1, forming part of a trolley.

12. A wheel according to claim 11, wherein the trolley is suitable for transporting a watercraft.

13. A wheel according to claim 11, wherein the trolley is suitable for transporting a kayak.

14. A kayak trolley incorporating one or more wheel(s) according to claim 1.
